(19) United States
(12) Patent Application Publication
(10) Pub. No.: US 2026/0249497 A1
(43) Pub. Date: Aug. 27, 2026

(54) USE OF RETAINING MEMBER IN A SHAVING UNIT FOR LIGHT GUIDING

(71) Applicant: KONINKLIJKE PHILIPS N.V., EINDHOVEN (NL)

(72) Inventors: ELVIRA JOHANNA MARIA PAULUSSEN, Reppel-Bocholt (BE); MARIUS IOSIF BOAMFA, VELDHOVEN (NL); BABU VARGHESE, EINDHOVEN (NL); ELDERT ZEINSTRA, DRACHTEN (NL)

(21) Appl. No.: 18/878,130

(22) PCT Filed: May 16, 2023
(86) PCT No.: PCT/EP2023/063123

§ 371 Date: Dec. 23, 2024

(30) Foreign Application Priority Data
Jun. 21, 2022 (EP) 22180164.0

(51) Int. Cl. B26B 19/46; B26B 19/14; F21L 4/08; F21W 111/10; F21Y 115/10

(52) U.S. Cl. CPC B26B 19/46; B26B 19/14; F21L 4/08; F21V 2200/20; F21W 2111/10; F21Y 2115/10

(57) ABSTRACT

In a shaving unit (3) for an electric shaver, which is of the type comprising at least one hair-cutting unit, a base member (6) having a hair-collecting chamber (61), a supporting member (5) releasably mounted on the base member (6) and configured to support the hair-cutting unit, and a retaining member (7) connected to the supporting member (5) and configured to retain the hair-cutting unit in an operational position relative to the supporting member (5), at least one light source is applied for illuminating a skin of a user via at least a portion of a skin-contacting surface (51) of the supporting member (5) during use of the shaving unit (3). Both a portion of the supporting member (5) comprising said portion of the skin-contacting surface (51) and a portion of the retaining member (7) are optically transparent, wherein the latter portion serves for guiding and spreading light generated by the light source.

### FIELD OF THE INVENTION

The invention relates to a shaving unit for an electric shaver, comprising:
at least one hair-cutting unit having an external cutting member with hair-entry openings and an internal cutting member which is movable relative to the external cutting member and covered by the external cutting member;
a base member having a hair-collecting chamber arranged for collecting hairs cut by the hair-cutting unit;
a supporting member releasably mounted on the base member and configured to support the hair-cutting unit, said supporting member having a skin-contacting surface arranged to contact a skin of a user during use of the shaving unit, said skin-contacting surface at least partially surrounding the hair-cutting unit;
a retaining member connected to the supporting member and configured to retain the hair-cutting unit in an operational position relative to the supporting member, said operational position being between the skin-contacting surface of the supporting member and the retaining member; and
at least one light source configured to generate light for illuminating the skin of the user via at least a portion of the skin-contacting surface of the supporting member during use of the shaving unit, wherein a portion of the supporting member comprising said portion of the skin-contacting surface is optically transparent.

Further, the invention relates to an electric shaver comprising a main body and a shaving unit as mentioned here before, coupled to the main body.

### BACKGROUND OF THE INVENTION

A shaving unit as mentioned here before is known in the art, such as from WO 2022/069324 A1. Besides at least one hair-cutting unit and a supporting member supporting the at least one hair-cutting unit, the shaving unit known from WO 2022/069324 A1 comprises at least one skin-heating unit comprising at least one infrared or near-infrared light source. The hair-cutting unit is of the type comprising an external cutting member which has hair-entry openings in a cutting track surface and an internal cutting member which has at least one hair-cutting element and which is movable relative to the external cutting member. The skin-heating unit further comprises a skin-contacting member having a skin-contacting surface arranged adjacent to the at least one hair-cutting unit to contact the skin during use of the shaving unit, wherein the at least one infrared or near-infrared light source is integrated in the skin-contacting member, thermally coupled to the skin-contacting surface and arranged to emit the infrared or near-infrared light via the skin-contacting surface.

A reason for equipping a shaving unit with a skin-heating unit is found in the fact that exposure of hairs to infrared or near-infrared light helps to soften the hairs. In general, exposure of hairs to infrared or near-infrared light during a shaving action improves the comfort experienced by the user. Also, infrared or near-infrared light may have a beneficial effect on the skin, stimulating the skin and invoking a radiant look of the skin. The fact is that the skin-heating unit is functional to achieve an effect referred to as deep optical-thermal heating. Deep optical-thermal heating is different from conductive thermal heating by a heat applicator including hot elements in conductive thermal contact with the skin, because the penetration depth of light into the skin is relatively high, generally up to 1 mm when blue light is used, and several millimeters when infrared or red light is used. The skin is heated over the entire depth of light penetration without needing to rely on thermal conductivity of both the heat applicator and the skin. During use of the shaving unit known from WO 2022/069324 A1 and operation of the skin-heating unit of the shaving unit, a combination of deep optical-thermal heating and conductive thermal heating of the skin is obtained as a consequence of, respectively, the application of the infrared or near-infrared light to the skin and the thermal coupling of the light source to the skin-contacting surface, the latter resulting in the conductive heating of the skin by residual heat generated by the light source. In this respect, it is noted that in general, any light source has a limited efficiency in converting electric power into optical power, and part of the electric power supplied to a light source is converted into thermal energy, so that a light source generates not only light but also residual heat during operation.

An issue in the field of heating skin by means of one or more light sources integrated in a shaving unit is insufficient optical spreading of the light over the surface through which the skin is contacted during a combined action of removing hairs from the skin and emitting light to the skin. This is not only an issue when the light is infrared or near-infrared light, but also when another type of light is applied, such as blue light which is suitable for achieving anti-bacterial effects and which is applicable in various fields including the field of treatment of acne, or red light which is suitable for achieving anti-inflammatory effects and which is applicable in various fields including the field of wound healing. The fact is that insufficient optical spreading of the light involves an associated risk that local high intensity light spots are created, which may cause the user to experience an uncomfortable pain sensation and/or which may reduce effectiveness of the intended skin treatment or even cause damage to the skin. Also, insufficient optical spreading is undesirable in view of photobiological and thermal eye safety.

Furthermore, another issue of the shaving unit known from WO 2022/069324 A1 is that the light intensity that can be applied to the skin may be limited by the amount of conductive thermal heating of the skin. In particular, when using light of different colors for other skin benefits than skin heating, relatively high light intensities might be needed to obtain sufficient efficiency of the light treatment. Such higher light intensities might not be possible because of the relatively high amount of residual heat of the light sources that is thermally conducted to the skin.

It is an object of the invention to provide a shaving unit which comprises at least one light source configured to generate light for illuminating the skin of a user and which is designed such that the creation of local high intensity light spots on the skin during use of the shaving unit is avoided, preferably without needing to make significant amendments to the generally known set-up of existing shaving units. It is another object of the invention to significantly reduce the thermal conduction of the residual heat of the light sources to the skin-contacting surface of the supporting member, so that an amount of light that can be directed to the skin is not limited by an unallowable degree of heating of the skin by the residual heat of the light sources.

### SUMMARY OF THE INVENTION

The invention provides a shaving unit for an electric shaver, comprising:
at least one hair-cutting unit having an external cutting member with hair-entry openings and an internal cutting member which is movable relative to the external cutting member and covered by the external cutting member;
a base member having a hair-collecting chamber arranged for collecting hairs cut by the hair-cutting unit;
a supporting member releasably mounted on the base member and configured to support the hair-cutting unit, said supporting member having a skin-contacting surface arranged to contact a skin of a user during use of the shaving unit, said skin-contacting surface at least partially surrounding the hair-cutting unit;
a retaining member connected to the supporting member and configured to retain the hair-cutting unit in an operational position relative to the supporting member, said operational position being between the skin-contacting surface of the supporting member and the retaining member; and
at least one light source configured to generate light for illuminating the skin of the user via at least a portion of the skin-contacting surface of the supporting member during use of the shaving unit; wherein:
a portion of the supporting member comprising said portion of the skin-contacting surface is optically transparent;
the retaining member has an optically transparent light-guiding portion;
the light source is arranged such that light generated by the light source is optically coupled into the light-guiding portion of the retaining member; and
the light-guiding portion of the retaining member has a light-outcoupling surface and is configured to guide the light received from the light source and to outcouple the light via the light-outcoupling surface in a direction towards the optically transparent portion of the supporting member.

It follows from the foregoing that notable features of the shaving unit according to the invention are optical transparency of a portion of the supporting member comprising a portion of the skin-contacting surface and optical transparency of a portion of the retaining member, which portion of the retaining member is referred to as light-guiding portion of the retaining member. The light source, the light-guiding portion of the retaining member and the optically transparent portion of the supporting member are positioned in such a way relative to each other that during operation, light generated by the light source is optically coupled into the light-guiding portion of the retaining member, travels through the light-guiding portion of the retaining member, and is outcoupled towards the optically transparent portion of the supporting member. In this way, the light generated by the light source is enabled to reach the relevant portion of the skin-contacting surface of the supporting member.

It is clear from the above explanation that according to the invention, a portion of the retaining member is functional to guide and direct the light from the light source to the optically transparent portion of the supporting member. Thus, use is made of existing components of the conventional shaving unit, i.e., the retaining member and the supporting member, for the purpose of ensuring that the light is enabled to travel through the shaving unit. Putting the invention to practice involves choosing an effective relative positioning of the light source, the light-guiding portion of the retaining member and the optically transparent portion of the supporting member, besides making at least part of the retaining member and the supporting member from optically transparent material. Examples of suitable optically transparent material are polycarbonate and polymethylmethacrylate. It is to be noted that the light-guiding portion of the retaining member and the optically transparent portion of the supporting member may be made of the same optically transparent material, but that this is not necessary in the context of the invention. The spatial appearance of the retaining member, on the basis of which the retaining member is functional to support the hair-cutting unit in the shaving unit, provides a practical basis for obtaining homogeneous spreading of the light applied to the skin of a user, in particular via the light-guiding portion of the retaining member, when the shaving unit is used in a shaving action. In this way, high efficacy of the treatment of the skin is achieved while creation of local high intensity light spots which may be harmful to the skin and/or the eye is prevented. Furthermore, the arrangement of the retaining member at a distance from the supporting member, as a consequence of the hair-cutting unit being held in its operational position between the retaining member and the skin-supporting surface of the supporting member, allows the light source to be arranged at a distance from the skin-supporting surface, i.e., without any relatively short direct thermally conductive path between the light source and the skin-contacting surface.

The invention covers any suitable position of the light source in the shaving unit. Practical options in this respect include an option of the light source being mounted to the light-guiding portion of the retaining member, an option of the light source being mounted to the supporting member, and an option of the light source being mounted in a bottom wall or in a side wall of the hair-collecting chamber of the base member. In respect of the latter two options, it is noted that it is practical if the light-guiding portion of the retaining member comprises a light-incoupling surface configured to receive the light generated by the light source in an operational condition of the shaving unit, i.e., a condition of the shaving unit in which the retaining member is coupled to the supporting member and the supporting member is coupled to the base member. In particular, the option wherein the light source is mounted to the light-guiding portion of the retaining member and the options wherein the light source is mounted to the hair-collecting chamber of the base member provide an optimal reduction of the thermal conduction of the residual heat of the light source to the skin-contacting surface of the supporting member.

In a practical embodiment of the shaving unit according to the invention, the retaining member is releasably coupled to the supporting member to enable removal of the hair-cutting unit from the shaving unit in a de-coupled condition of the retaining member.

In respect of the light-outcoupling surface of the light-guiding portion of the retaining member, it is noted that one of various practical positions of said surface is a position in which said surface extends parallel to the skin-contacting surface of the supporting member. This allows a design wherein the light-outcoupling surface of the light-guiding portion of the retaining member extends parallel to a relatively large portion of the skin-contacting surface, so that the optical spreading of the light over the skin-contacting surface will be further improved. Further, it is noted that the invention covers an option according to which the light-guiding portion of the retaining member comprises a light-outcoupling structure which is provided on one of the light-outcoupling surface of the light-guiding portion and a main surface of the light-guiding portion opposite to the light-outcoupling surface. In the context of this option, it may be practical if the other one of the light-outcoupling surface of the light-guiding portion and the main surface of the light-guiding portion opposite to the light-outcoupling surface is without structure, i.e., even. To put it differently, the light-coupling structure can be located at a side of the light-guiding portion where the light is coupled out or at an opposite side, i.e., a side where no light is coupled out. A further possible feature is that the main surface of the light-guiding portion opposite to the light-outcoupling surface is provided with an optically reflective coating. In a situation in which such a coating is omitted, reflection of the light in the light-guiding portion may still take place, namely on the basis of total internal reflection.

In practical cases, such as cases of the light source being a light emitting diode (LED), the light source is configured to emit the light in a main light-emission direction. It is advantageous if an orientation of the light source in the shaving unit is chosen so as to be appropriate in view of the design of the light source, the retaining member and the supporting member and the positioning of those components of the shaving unit relative to each other. For example, a choice may be made according to which said main light-emission direction of the light source is parallel or perpendicular to the light-outcoupling surface of the light-guiding portion of the retaining member.

During use of the shaving unit according to the invention, the skin of the user is illuminated via at least a portion of the skin-contacting surface of the supporting member, as explained in the foregoing. An even larger illumination area is obtained if at least a portion of the hair-cutting unit is also used for conveying light to the skin, and in view thereof, an advantageous option of the hair-cutting unit being at least partially optically transparent, and the light-guiding portion of the retaining member being configured to outcouple the light received from the light source via the light-outcoupling surface also in a direction towards the hair-cutting unit is included in the invention. For example, it is possible that the hair-entry openings of the external cutter member of the hair-cutting unit are used to pass on light to the skin. Additionally or alternatively, it is possible that the external cutting member is provided with a centrally arranged open channel, about which the internal cutting member is rotatable and which is covered, at a skin-facing side of the external cutting member, by an optically transparent cap.

In a practical embodiment, the shaving unit comprises more than one hair-cutting units, particularly three hair-cutting units arranged in a triangular configuration about a central axis of the hair-cutting unit. In such an embodiment, in order to achieve useful spreading of the light over the optically transparent portion of the supporting member of the shaving unit as desired, it is advantageous if:
the retaining member has a central portion and three light-guiding portions mounted to the central portion in a triangular configuration about the central axis;
the shaving unit comprises at least one light source associated with each of the light-guiding portions of the retaining member; and
each respective light-guiding portion of the retaining member is configured to guide the light received from the at least one light source associated with the respective light-guiding portion and to outcouple the light in a direction towards a respective one of three sections of the optically transparent portion of the supporting member.

In order to further promote uniform spreading of the light over the optically transparent portion of the supporting member and to limit or even prevent loss of light to other portions of the shaving unit than the optically transparent portion of the supporting member, it is advantageous if internal surfaces of the shaving unit are provided with an optically reflective coating, said internal surfaces including at least one of:
an internal surface of the hair-collecting chamber of the base member;
an internal surface of the supporting member;
a surface of the internal cutting member of the hair-cutting unit;
a surface of a drive member arranged in the base member for driving the internal cutting member; and
a surface of the light-guiding portion of the retaining member other than the light-outcoupling surface and other than a light-incoupling surface where light is received from the light source.

The above-described and other aspects of the invention will be apparent from and elucidated with reference to the following detailed description of a number of embodiments of a shaving unit comprising three hair-cutting units, a supporting member for supporting the hair-cutting units, and a retaining member for retaining the hair-cutting units in an operational position relative to the supporting member, wherein the shaving unit further comprises at least one light source configured to generate light for illuminating the skin of the user via at least a portion of the skin-contacting surface of the supporting member during use of the shaving unit, and wherein the shaving unit is designed so as to provide a path for the light from the light source to said portion of the skin-contacting surface through the retaining member.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of an electric shaver according to an embodiment of the invention, which electric shaver comprises a shaving unit and a main body;

FIG. 2 diagrammatically shows one of three hair-cutting units of the shaving unit, wherein an external cutting member and an internal cutting member of the hair-cutting unit are shown in an exploded perspective view;

FIG. 3 diagrammatically shows a perspective view of the shaving unit without the hair-cutting units, in an opened condition in which a hair-collecting chamber provided in a base member of the shaving unit is accessible;

FIG. 4 diagrammatically shows a perspective view of a retaining member of the shaving unit;

FIG. 5 diagrammatically shows a top view of a supporting member of the shaving unit, which serves for supporting the hair-cutting units;

FIGS. 6-9 illustrate four options in respect of the positioning of LEDs on the retaining member;

FIG. 10 illustrates how light is reflected in a light-guiding portion of the retaining member and is outcoupled from said light-guiding portion when the option illustrated in FIG. 9 is applied;

FIG. 11 illustrates an option in respect of the positioning of LEDs on the supporting member;

FIGS. 12 and 13 illustrate two options in respect of the positioning of LEDs in the hair-collecting chamber of the base member;

FIG. 14 illustrates how the light-guiding portion and an LED are positioned relative to each other in an operational condition of the shaving unit in case the LEDs are positioned in side walls of the hair-collecting chamber;

FIGS. 15 and 16 illustrate two options in respect of a light-outcoupling structure of the retaining member; and

FIG. 17 illustrates an option of the hair-cutting units being provided with further openings for light throughput.

### DETAILED DESCRIPTION OF THE EMBODIMENTS

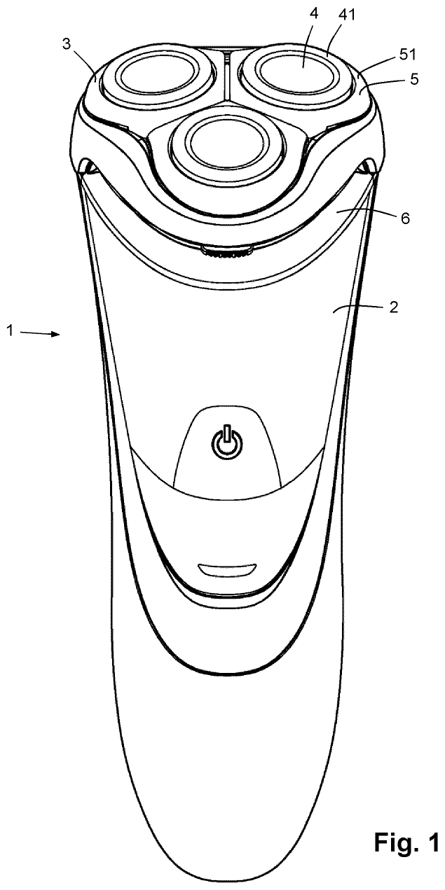

FIG. 1 shows an electric shaver of the rotary type, which is suitable to be used for shaving a beard, as a practical example of an electric shaver 1 according to an embodiment of the invention. The electric shaver 1 comprises a main body 2 and a shaving unit 3, wherein the main body 2 is designed to enable a user of the shaver 1 to take hold of the shaver 1 and to handle the shaver 1, and wherein the shaving unit 3 is the part of the shaver 1 that is to be positioned on and moved over the skin for hair removal. In the present example, the shaving unit 3 comprises three hair-cutting units 4 and a supporting member 5 supporting the hair-cutting units 4. The supporting member 5 has a skin-contacting surface 51 arranged to contact a skin of a user during use of the shaving unit 3. In the present example, the skin-contacting surface 51 surrounds each of the hair-cutting units 4.

When the electric shaver 1 is actually applied for the purpose of performing a shaving action, the actual process of cutting of hairs protruding from the skin takes place at the position of the hair-cutting units 4. In the context of the invention, the number of hair-cutting units 4 can be chosen freely and does not necessarily need to be three. The main body 2 may have a function in accommodating at least one electric motor for driving components of the respective hair-cutting units 4. The main body 2 may further include means such as a rechargeable battery for powering the at least one electric motor. It is practical if the shaving unit 3 and the main body 2 are releasably connectable to each other, as known per se in the field of electric shavers.

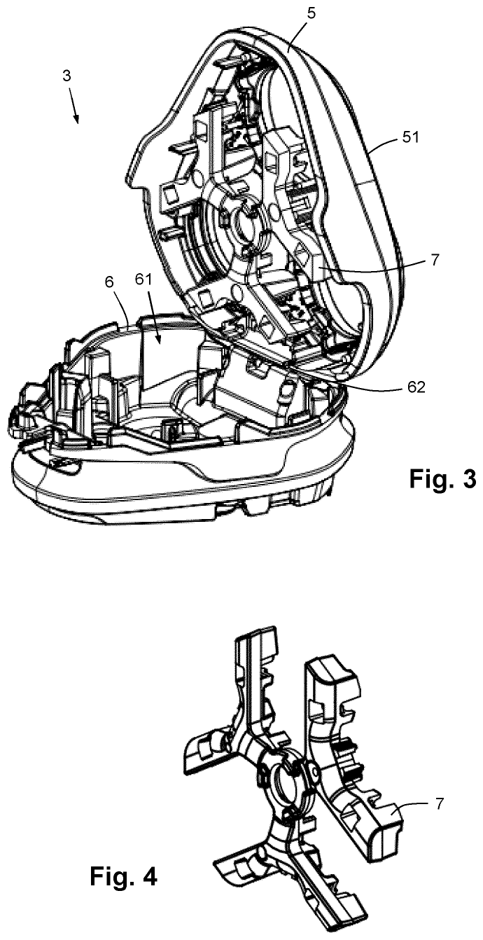

Besides the hair-cutting units 4 and the supporting member 5, the shaving unit 3 comprises a base member 6, wherein the supporting member 5 is releasably mounted on the base member 6. In FIG. 3, an opened condition of the shaving unit 3 is shown, in which condition the supporting member 5 is hinged to a non-operational position relative to the base member 6. Further, in FIG. 3, it can be seen that the base member 6 has a hair-collecting chamber 61 which serves for collecting hairs cut by the hair-cutting units 4 during a shaving action. The shaving unit 3 also comprises a retaining member 7 which is connected to the supporting member 5 in an operational condition of the shaving unit 3 and which serves to retain the hair-cutting units 4 in an operational position relative to the supporting member 5, namely a position which is a position between the skin-contacting surface 51 of the supporting member 5 and the retaining member 7 as seen in a direction along a longitudinal axis of the shaving unit 3.

Advantageously, the retaining member 7 is releasably coupled to the supporting member 5 in order to enable removal of the hair-cutting units 4 from the shaving unit 3 in a de-coupled condition of the retaining member 7 as shown in FIG. 4.

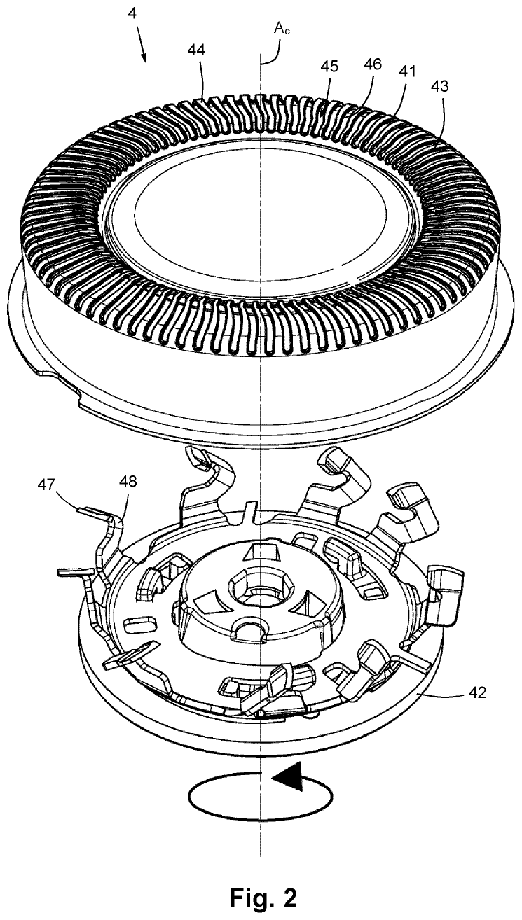

Each of the hair-cutting units 4 comprises a combination of an external cutting member 41 and an internal cutting member 42. Details of the combination of the external cutting member 41 and the internal cutting member 42 are now described with reference to FIG. 2. The external cutting member 41 is of a generally cup-shaped design and is thereby suitable for at least partially accommodating the internal cutting member 42 in its interior. The external cutting member 41 has an annular shaving track 43, wherein an upper surface of the shaving track 43 serves to face and contact the skin to be subjected to a shaving action. The shaving track 43 comprises lamellae 44 extending along the width of the shaving track 43, in a substantially radial direction relative to a central axis Ac of the hair-cutting unit 4, which coincides with a rotational axis about which the internal cutting member 42 is rotatable relative to the external cutting member 41. Apertures as present between the lamellae 44 constitute hair-entry openings 45 of the shaving track 43. Sides of the lamellae 44 constitute hair-cutting surfaces 46 suitable for cutting off hairs in cooperation with hair-cutting edges 47 of hair-cutting elements 48 of the internal cutting member 42. The invention also relates to cases in which the shaving track 43 does not comprise lamellae 44 or does not only comprise lamellae 44, such as cases in which the entire shaving track 43 is provided with teeth-like elements and/or a pattern of (circular) holes instead of or in addition to lamellae 44. Also, the invention relates to cases in which more than one shaving tracks 43 are present in the external cutting member 41.

A shaving action can be performed when the internal cutting member 42 is activated to rotate and a portion of skin is actually contacted by the external cutting member 41 at the position of the shaving track 43. A direction of rotation about the central axis Ac is indicated in FIG. 2 by means of an arrow. Activation of the internal cutting member 42 may take place in a known manner by means of a drive mechanism of the electric shaver 1. When the combination of the external cutting member 41 and the internal cutting member 42 is moved over the portion of skin while the internal cutting member 42 is driven to rotate, it is achieved that hairs protruding from the portion of skin are caught in the hair-entry openings 45 of the shaving track 43 of the external cutting member 41 and are cut off in that position as result of a cooperation between the hair-cutting surfaces 46 of the shaving track 43 of the external cutting member 41 and the hair-cutting edges 47 of the hair-cutting elements 48 of the rotating internal cutting member 42.

The shaving unit 3 is not only configured to perform a shaving action on the user's skin, but also to emit light to the skin. To that end, the shaving unit 3 comprises at least one light source configured to generate light for illuminating the skin via at least a portion of the skin-contacting surface 51 of the supporting member 5 during use of the shaving unit 3. The shaving unit 3 is designed to enable to light to follow a path that extends from the light source to said portion of the skin-contacting surface 51 and through the retaining member 7. In particular, the shaving unit 3 has the following features:
a portion of the supporting member 5 comprising said portion of the skin-contacting surface 51 is optically transparent;
the retaining member 7 has an optically transparent light-guiding portion;
the light source is arranged such that light generated by the light source is optically coupled into the light-guiding portion of the retaining member 7; and
the light-guiding portion of the retaining member 7 has a light-outcoupling surface and is configured to guide the light received from the light source and to outcouple the light via the light-outcoupling surface in a direction towards the optically transparent portion of the supporting member 5.

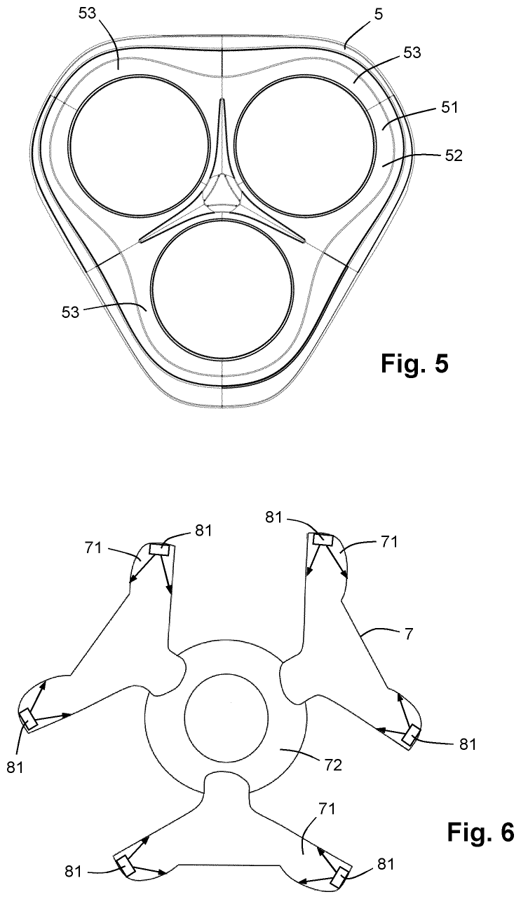

An example of the appearance of the supporting member 5 with the optically transparent portion 52 is shown in FIG. 5. In the shown example, three sections 53 extending radially outward from a central area of the supporting member 5 can be distinguished in the optically transparent portion 52. The retaining member 7 can be entirely optically transparent, in which case the optically transparent light-guiding portion 71 of the retaining member 7 takes up all of the retaining member 7, or the retaining member 7 can be partially optically transparent. In either case, on the basis of the features listed above, it is achieved that the mechanical mount which keeps the hair-cutting unit 4 in place and for a large extent covers an area behind the optically transparent portion 52 of the supporting member 5 is functional as light guide and light spreader, so that the portion of the skin-contacting surface 51 included in the optically transparent portion 52 of the supporting member 5 functions as skin-illumination area while uniform light distribution is provided in said area so that occurrence of local high intensity light spots in said area is avoided. Thus, the retaining member 7 has a combined mechanical and optical function. The retaining member 7 is entirely or partially made from an optically transparent material such as polycarbonate or polymethylmethacrylate. The optically transparent portion 52 of the supporting member 5 is also made from an optically transparent material, which material is optionally scattering diffusive, i.e., frosted material. It is practical if the light-outcoupling surface of the light-guiding portion 71 of the retaining member 7 extends parallel to the skin-contacting surface 51 of the supporting member 5.

The one or more light sources may be of any suitable type, chosen in dependence on the intended effect of the light on the skin. In the following, it is assumed that the light sources are LEDs 81. There are various possibilities when it comes to placing the LEDs 81 in the shaving unit 3. In all of the possible cases, the positioning of the LEDs 81 and the positioning of optically transparent material in the retaining member 7 and the supporting member 5 is such that light is enabled to reach the light-guiding portion 71 of the retaining member 7, to be guided by the light-guiding portion 71 and to be spread throughout the light-guiding portion 71 in the process, and to reach the optically transparent portion 52 of the supporting member 5 from the light-guiding portion 71. The light is successively coupled into the light-guiding portion 71, coupled out of the light-guiding portion 71, and coupled in to the optically transparent portion 52 of the supporting member 5 so that the light can eventually be outcoupled from the skin-contacting surface 51 and reach skin which is actually contacted by the skin-contacting surface 51. Examples of how the LEDs 81 can be mounted to three generally double wing-shaped light-guiding portions 71 of the retaining member 7 are illustrated in FIGS. 6-9, wherein in FIGS. 6-8, light emitted from the LEDs 81 is indicated by means of arrows. Powering of the LEDs 81 can take place through spring-loaded contacts, for example, wherein electric contact of the LEDs 81 to a power source is established in the operational condition of the shaving unit 3, and wherein it is possible to temporarily interrupt such electric contact when the shaving unit 3 is put to the opened condition and when the retaining member 7 is removed from the supporting member 5 in that situation.

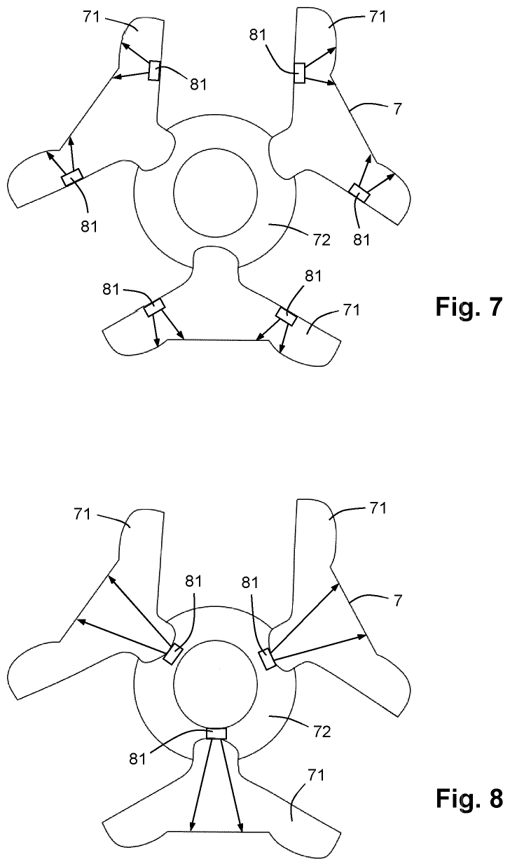

In the examples illustrated in FIGS. 6-8, optical coupling of the light into the light-guiding portions 71 takes place in a direction parallel to the skin-contacting surface 51 of the supporting member 5. In the example illustrated in FIG. 6, six LEDs 81 are applied, each of the LEDs 81 being placed at a tip of a wing of one of the light-guiding portions 71 of the retaining member 7. In that case, in order to obtain optimal light spreading, it is practical if the LEDs 81 are narrow viewing angle LEDs. In the example illustrated in FIG. 7, six LEDs 81 are applied, each of the LEDs 81 being placed at a position approximately half-way a wing of one of the three light-guiding portions 71. In that case, in order to obtain optimal light spreading, it is practical if the LEDs 81 are batwing top emitters or side emitters. In the example illustrated in FIG. 8, three LEDs 81 are applied, each of the LEDs 81 being placed at a central side position on one of the three light-guiding portions 71. In that case, in order to obtain optimal light spreading, it is practical if the LEDs 81 are wide viewing angle LEDs. Further, in that case, a central portion 72 of the retaining member 7 can be used as heat sink. In a feasible alternative, a single (high power) side emitting LED is used, at a position on the central portion 72, and the retaining member 7 is configured such that light paths from the central portion 72 to the respective light-guiding portions 71 are realized. Advantages of such alternative are the reduction of the number of LEDs 81, which involves a reduction of costs and an increase of sustainability, and concentration of thermal power at a central position of the shaving unit 3.

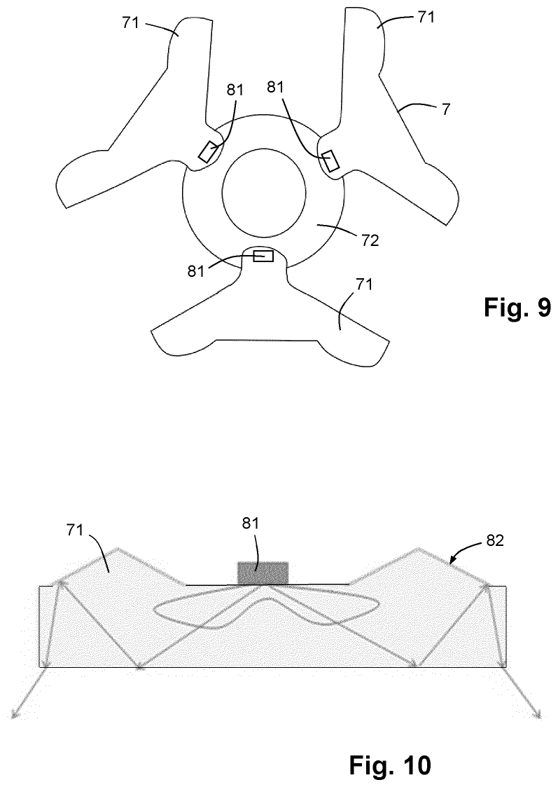

In the example illustrated in FIG. 9, three LEDs 81 are applied, each of the LEDs 81 being placed at a central front position on one of the three light-guiding portions 71. Light emission from the LEDs 81 takes place in a direction perpendicular to the skin-contacting surface 51 of the supporting member 5, and the LEDs 81 can be batwing top emitters or side emitters. Also in that case, the central portion 72 of the retaining member 7 can serve as a heat sink. An example of a batwing top emitter is illustrated in FIG. 10, wherein it is indicated how light may travel from the LED 81 through the light-guiding portion 71 by means sets of arrows. An optional optically reflecting coating 82 of the light-guiding portion 71 at the side where the LED 81 is positioned is shown in FIG. 10 as well.

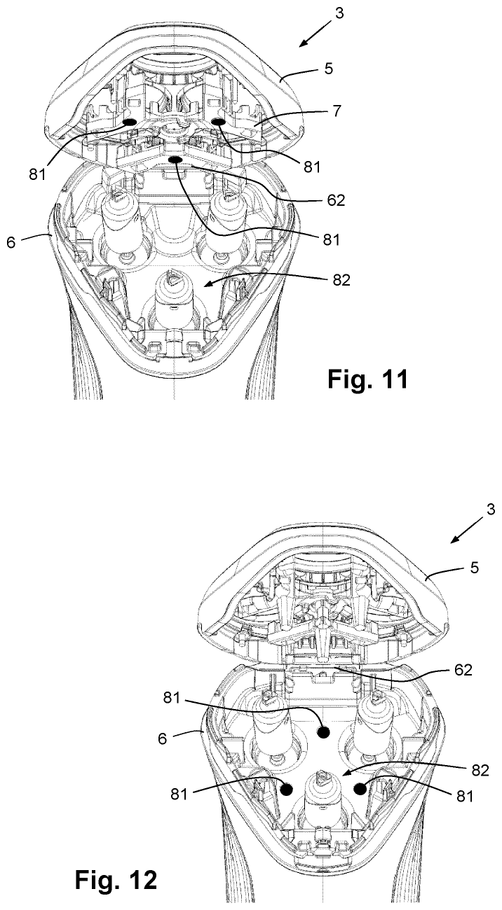

An example of how the one or more LEDs 81 can be mounted to the supporting member 5 is illustrated in FIG. 11. In the shown example, as indicated by means of three dots in the figure, three LEDs 81 are present at positions which are aligned with the light-guiding portions 71 of the retaining member 7, on a central bracket-like piece of the supporting member 5. Light emission from the LEDs 81 takes place in a direction perpendicular to the skin-contacting surface 51 of the supporting member 5, and the LEDs 81 can be batwing top emitters or side emitters. The LEDs 81 can be powered through a transit inside a hinge 62 as present between the base member 6 and the supporting member 5 in the present example.

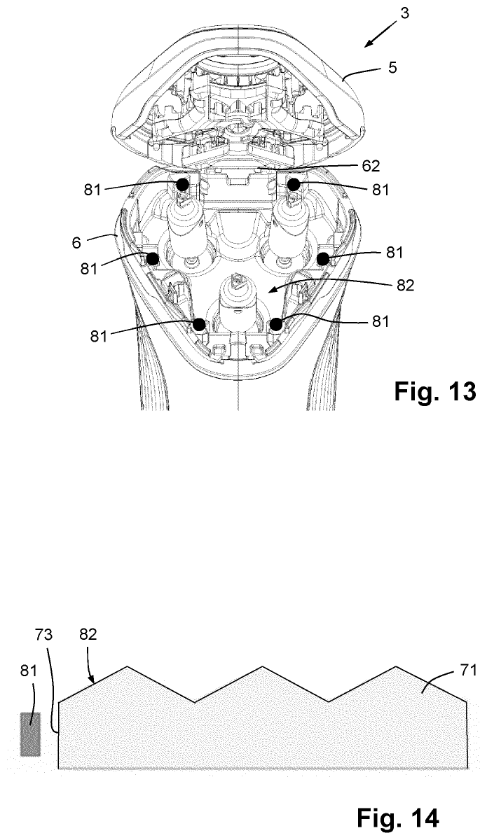

Examples of how the one or more LEDs 81 can be mounted to the base member 6 are illustrated in FIGS. 12 and 13. An advantage of such positioning of the LEDs 81 is that the LEDs 81 are at a stationary position in the shaving unit 3 so that electric powering of the LEDs 81 can do without special measures aimed at enabling coupling and decoupling. In the example illustrated in FIG. 12, as indicated by means of three dots in the figure, three LEDs 81 are applied, each of the LEDs 81 being positioned in a bottom wall of the hair-collecting chamber 61. In the example illustrated in FIG. 13, as indicated by means of six dots in the figure, six LEDs 81 are applied, each of the LEDs 81 being positioned in a side wall of the hair-collecting chamber 61. In the operational condition of the shaving unit 3, optical coupling of the LEDs 81 and the light-guiding portions 71 of the retaining member 7 is established, so that the light-guiding portions 71 are enabled to receive light generated by the LEDs 81. An illustration thereof pertaining to the option of the LEDs 81 being positioned in a side wall of the hair-collecting chamber 61 is provided by means of FIG. 14. In FIG. 14, it can be seen how the light-guiding portion 71 and the LED 81 shown are positioned in such a way relative to each other that the light-guiding portion 71 is enabled to receive light from the LED 81 at the position of a light-incoupling surface 73. In this respect, it is noted that the invention covers an option of using an add-on on the light-guiding portion 71 which is shaped so as to optimize the light-incoupling process without needing to amend an existing shape of the retaining member 7.

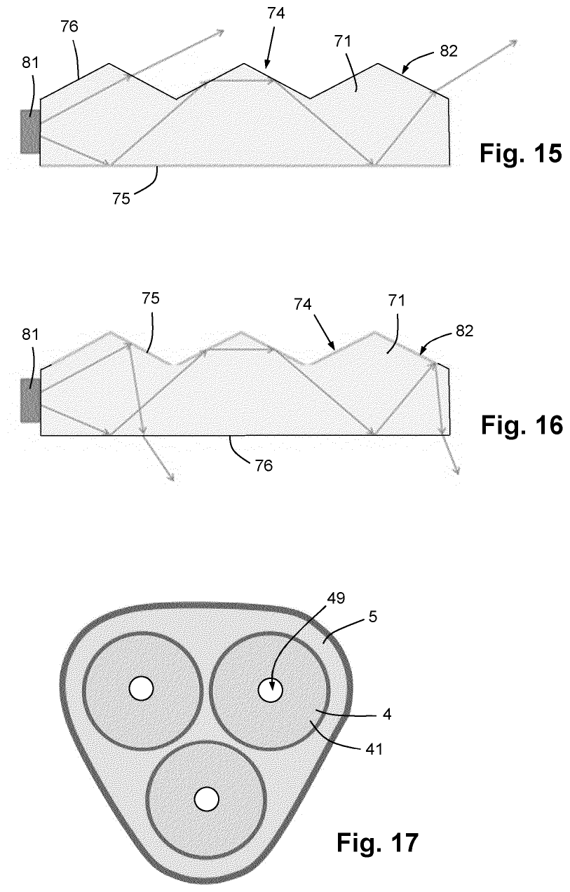

In order to promote spreading of the light, the internal surface of the hair-collecting chamber 61 is preferably provided with an optically reflective coating 82. In this respect, it is noted that other surfaces in the shaving unit 3 may be provided with such a coating as well, such as an internal surface of the supporting member 5, a surface of the internal cutting member 42 of the hair-cutting unit 4, a surface of a drive member arranged in the base member 6 for driving the internal cutting member 42, and a surface of the retaining member 7 outside of the areas on the retaining member 7 where light is coupled into and out of the light-guiding portion(s) 71. The reflective characteristics of the coating 82 contribute to obtaining the desired effect of emitting the light to the skin in an evenly distributed fashion. FIGS. 15 and 16 illustrate two options in respect of a light-outcoupling structure 74 of the light-guiding portion 71 of the retaining member 7. In the figures, a LED 81 is shown at a position in which the LED 81 is mounted to the light-guiding portion 71. Further, in the figures, the possibility of a main surface 75 opposite to the light-outcoupling surface 76 being provided with an optically reflective coating 82 is illustrated. In FIG. 15, it is shown how the light-outcoupling structure 74 can be present at the light-outcoupling surface 76 while the main surface 75 has an even appearance, whereas in FIG. 16, it is shown how the light-outcoupling structure 74 can be present at the main surface 75 while the light-outcoupling surface 76 has an even appearance. In both figures, an indication of what the associated path of the light through the light-guiding portion looks like is provided by means of sets of arrows. Generally speaking, the structure of the main surface 75 and the light-outcoupling surface 76 may be chosen such that outcoupling of the light from the light-guiding portion 71 is promoted based on local orientations of the respective surface 75, 76.

FIG. 17 illustrates an option aimed at having a larger skin-illumination area than just an area at the position of a portion of the skin-contacting surface 51 of the supporting member 5, namely by involving an area at the position of the hair-cutting units 4 in conveying light to the skin. Use can be made of the hair-entry openings 45 of the external cutting member 41, but it is also possible to provide the external cutting member 41 with at least one further opening 49 of larger constitution, as illustrated in FIG. 17. In this respect, it is practical if the external cutting member 41 is provided with a centrally arranged open channel 49 and if the internal cutting member 42 has corresponding openings. A central portion of the external cutting member 41 inside the area of the shaving track 43 is preferably covered by a cap, which is preferably optically transparent in case the centrally arranged open channel 49 is present in the external cutting member 41, indeed.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise.

Thus, the mere fact that certain measures are recited in mutually different dependent claims does not indicate that a combination of these measures cannot be used to advantage.

The terms “comprise” and “include” as used in the present text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

Generally known options such as an option of equipping the shaving unit 3 with one or more sensors for detecting characteristics such as skin temperature, skin tone and motion are applicable to the shaving unit 3 according to the invention. As explained, the at least one light source included in the shaving unit 3 may be an LED, and the wavelength or range of wavelengths of the light emitted by the LED may be chosen freely in dependence on the desired effect of the light on the skin. The invention covers all kinds of desired effects, such as anti-bacterial effects, anti-inflammatory effects, skin radiance boosting effects, skin re-energizing effects and effects mentioned earlier in the present text.

Notable aspects of the invention are summarized as follows. In a shaving unit 3 for an electric shaver 1, which is of the type comprising at least one hair-cutting unit 4, a base member 6 having a hair-collecting chamber 61, a supporting member 5 releasably mounted on the base member 6 and configured to support the hair-cutting unit 4, and a retaining member 7 connected to the supporting member 5 and configured to retain the hair-cutting unit 4 in an operational position relative to the supporting member 5, at least one light source 81 is applied for illuminating a skin of a user via at least a portion of a skin-contacting surface 51 of the supporting member 5 during use of the shaving unit 3. Both a portion 52 of the supporting member 5 comprising said portion of the skin-contacting surface 51 and a portion 71 of the retaining member 7 are optically transparent, wherein the latter portion 71 serves for guiding and spreading light generated by the light source 81.

1. Shaving unit (3) for an electric shaver (1), comprising:
at least one hair-cutting unit (4) having an external cutting member (41) with hair-entry openings (45) and an internal cutting member (42) which is movable relative to the external cutting member (41) and covered by the external cutting member (41);
a base member (6) having a hair-collecting chamber (61) arranged for collecting hairs cut by the hair-cutting unit (4);
a supporting member (5) releasably mounted on the base member (5) and configured to support the hair-cutting unit (4), said supporting member (5) having a skin-contacting surface (51) arranged to contact a skin of a user during use of the shaving unit (3), said skin-contacting surface (51) at least partially surrounding the hair-cutting unit (4);
a retaining member (7) connected to the supporting member (5) and configured to retain the hair-cutting unit (4) in an operational position relative to the supporting member (5), said operational position being between the skin-contacting surface (51) of the supporting member (5) and the retaining member (7); and
at least one light source (81) configured to generate light for illuminating the skin of the user via at least a portion of the skin-contacting surface (51) of the supporting member (5) during use of the shaving unit (3);
wherein:
a portion (52) of the supporting member (5) comprising said portion of the skin-contacting surface (51) is optically transparent;
the retaining member (7) has an optically transparent light-guiding portion (71);
the light source (81) is arranged such that light generated by the light source (81) is optically coupled into the light-guiding portion (71) of the retaining member (7); and
the light-guiding portion (71) of the retaining member (7) has a light-outcoupling surface (76) and is configured to guide the light received from the light source (81) and to outcouple the light via the light-outcoupling surface (76) in a direction towards the optically transparent portion (52) of the supporting member (5).

2. Shaving unit (3) as claimed in claim 1, wherein the light source (81) is mounted to the light-guiding portion (71) of the retaining member (7).

3. Shaving unit (3) as claimed in claim 1, wherein the light source (81) is mounted to the supporting member (5).

4. Shaving unit (3) as claimed in claim 1, wherein the light source (81) is mounted in a bottom wall or in a side wall of the hair-collecting chamber (61) of the base member (6).

5. Shaving unit (3) as claimed in claim 1, wherein the light-guiding portion (71) of the retaining member (7) comprises a light-incoupling surface (73) configured to receive the light generated by the light source (81) in an operational condition of the shaving unit (3).

6. Shaving unit (3) as claimed in any claim 1, wherein the retaining member (7) is releasably coupled to the supporting member (5) to enable removal of the hair-cutting unit (4) from the shaving unit (3) in a de-coupled condition of the retaining member (7).

7. Shaving unit (3) as claimed in an claim 1, wherein the light-outcoupling surface (76) of the light-guiding portion (71) of the retaining member (7) extends parallel to the skin-contacting surface (51) of the supporting member (5).

8. Shaving unit (3) as claimed in claim 1, wherein the light-guiding portion (71) of the retaining member (7) comprises a light-outcoupling structure (74) which is provided on the light-outcoupling surface (76) of the light-guiding portion (71) or on a main surface (75) of the light-guiding portion (71) opposite to the light-outcoupling surface (76).

9. Shaving unit (3) as claimed in claim 8, wherein the main surface (75) of the light-guiding portion (71) opposite to the light-outcoupling surface (76) is provided with an optically reflective coating (82).

10. Shaving unit (3) as claimed in claim 1, wherein a main light-emission direction of the light source (81) is parallel or perpendicular to the light-outcoupling surface (76) of the light-guiding portion (71) of the retaining member (7).

11. Shaving unit (3) as claimed in an claim 1, wherein the hair-cutting unit (4) is at least partially optically transparent, and wherein the light-guiding portion (71) of the retaining member (7) is configured to outcouple the light received from the light source (81) via the light-outcoupling surface (76) also in a direction towards the hair-cutting unit (4).

12. Shaving unit (3) as claimed in claim 11, wherein the external cutting member (41) of the hair-cutting unit (4) is provided with a centrally arranged open channel (49), about which the internal cutting member (42) is rotatable and which is covered, at a skin-facing side of the external cutting member (41), by an optically transparent cap.

13. Shaving unit (3) as claimed in an claim 1, comprising three hair-cutting units (4) arranged in a triangular configuration about a central axis (Ac) of the hair-cutting unit (4), and wherein:
the retaining member (7) has a central portion (72) and three light-guiding portions (71) mounted to the central portion (72) in a triangular configuration about the central axis (Ac);
the shaving unit (3) comprises at least one light source (81) associated with each of the light-guiding portions (71) of the retaining member (7); and
each respective light-guiding portion (71) of the retaining member (7) is configured to guide the light received from the at least one light source (81) associated with the respective light-guiding portion (71) and to outcouple the light in a direction towards a respective one of three sections (53) of the optically transparent portion (52) of the supporting member (5).

14. Shaving unit (3) as claimed in claim 1, wherein internal surfaces of the shaving unit (3) are provided with an optically reflective coating (82), said internal surfaces including at least one of:
an internal surface of the hair-collecting chamber (61) of the base member (6);
an internal surface of the supporting member (5);
a surface of the internal cutting member (42) of the hair-cutting unit (4);
a surface of a drive member arranged in the base member (6) for driving the internal cutting member (42); and
a surface of the light-guiding portion (71) of the retaining member (7) other than the light-outcoupling surface (76) and other than a light-incoupling surface (73) where light is received from the light source (81).

15. Electric shaver (1) comprising a main body (2) and a shaving unit (3) as claimed in claim 1, coupled to the main body (2).
